(19) United States
(12) Patent Application Publication
(10) Pub. No.: US 2019/0306689 A1
(43) Pub. Date: Oct. 3, 2019

(54) INTEGRATED DIALER WITH ELASTIC CALLING

(71) Applicant: TEXTNOW, INC., Waterloo (CA)

(72) Inventor: Armando Mauricio MURGA, Waterloo (CA)

(21) Appl. No.: 16/366,787

(22) Filed: Mar. 27, 2019

Related U.S. Application Data
(60) Provisional application No. 62/649,642, filed on Mar. 29, 2018.

(51) Int. Cl. H04W 4/90; H04W 76/15; H04W 72/08

(52) U.S. Cl. CPC H04W 4/90; H04W 84/12; H04W 72/085; H04W 76/15

(57) ABSTRACT

An integrated dialer (a software telephony application) with elastic calling features for mobile cellular devices. The integrated dialer would pass control of originating emergency service calls to the native dialer. It would automatically switch silently between wi-fi, PSTN, and cellular data services as needed depending on the quality of service (QoS) of the services. In addition, it would support the telephony services for multiple devices, each having the same telephone number.

### FIELD

The present invention relates to electronic communications.

### BACKGROUND

A mobile virtual network operator (MVNO) is a wireless communications services provider that does not own or operate the wireless network infrastructure over which the MVNO provides services to its customers. An MVNO may utilize a combination of any number of wireless technologies including those provided by any number of mobile network providers (such as cellular, LTE™) and those provided by any number of consumer establishments where Wi-Fi®, and the like, may be freely available to customers for Internet access.

A MVNO may use Voice over Internet Protocol (VoIP) which is a technology that provides voice communications services and data communications services (e.g., multimedia sessions) over Internet Protocol (IP) networks, such as the Internet and/or private packet networks. Typically, MVNOs offer a software telephony application using VoIP which can be installed on various devices such as handheld devices with Android or iOS operating systems, and desktop or laptop computers with Windows or Linux operating systems, for example. Further, VoIP technologies have evolved to include a telephone number for users and which include Short Message Service (SMS) for text messaging services.

These software telephony applications may be installed on mobile devices as well as fixed (hard-wired desktop) computers. A single user may have a number of fixed computers and mobile devices where the software telephony application is installed. It may be convenient for the user if the devices of the user all have the same telephone number.

These software telephony applications have a number of problems providing a quality service as well as the required emergency services. VoIP technology does not easily support various telephony features and capabilities that are provided by the Public Switched Telephone Network (PSTN). For example, to support emergency services calls to police, fire, ambulance, etc. (such as by dialing 9-1-1 in the United States), the mobile cellular device manufacturers have typically included a native dialer with high-level access permissions into the operating system so that information such as the physical geographical location of the device can be obtained for emergency responders. These permissions are not typical available to non-manufacturer developers of software applications.

Further, in order to take advantage of widely available “free” services such as wi-fi access points by businesses offering free Internet access for its customers as well as unlimited Internet access from the home, there is an inherent quality issue with using wi-fi for mobile services due to its limited range. A mobile device may leave wi-fi range or may be at the limits of the wi-fi range. It is therefore necessary to switch from one service to another when the quality drops.

### SUMMARY

According to one aspect of the present invention, there is provided an integrated dialer (a software telephony application) with elastic calling features for mobile devices. The integrated dialer would pass control of originating emergency service calls to the native dialer. It would automatically switch silently between wi-fi, PSTN, and cellular services as needed depending on the quality of service (QoS) of the services. In addition, it would support the telephony services for multiple devices, each having the same telephone number.

According to another aspect, there is provided an electronic communications system comprising: a mobile network to provide communications for a plurality of mobile communications devices over a wide-area IP network where mobile directory numbers are associated with the plurality of mobile communications devices; a wireless local-area network (WLAN) to provide communications for a plurality of communications devices over the wide-area IP network; a VoIP service coupled to the mobile network and the WLAN via the wide-area IP network, where the plurality of communications devices are associated with VoIP telephone numbers; a public switched telephone network (PSTN) coupled to the VoIP service; and a communications routing system coupled to the plurality of communications devices and coupled to the VoIP service; wherein at least one VoIP telephone number is associated with at least one of the plurality of communications devices, wherein the plurality of communications devices comprising the plurality of mobile communications devices, and wherein at least one of the plurality of mobile communications devices comprising an integrated dialer and a native dialer.

According to a further aspect, there is provided an electronic communications system comprising a quality of service server coupled to the plurality of mobile communications devices via the wide-area IP network for determining the quality of data channels to mobile communications devices via the mobile network and to the mobile communications devices via the WLAN; wherein the integrated dialer switches a voice call between one of the mobile network, the WLAN, and the PSTN depending on the quality of the data channels.

According to a further aspect, there is provided an electronic communications system wherein the integrated dialer passes control to the native dialer to originate telephone calls to telephone numbers which are included in a set of predetermined telephone numbers. Optionally, the set of predetermined telephone numbers comprises emergency telephone numbers.

According to a further aspect, there is provided an electronic communications system wherein the communications routing system notifies all of the communication devices associated with a VoIP telephone numbers of an incoming voice call to the VoIP telephone number. Optionally, where one of the all of the communication devices answers the incoming voice call, the communications routing system notifies the other devices of the all of the communication devices that the incoming voice call has been answered. Further optionally, all of the communication devices display that the incoming voice call has been answered.

According to a further aspect, there is provided an electronic communications system where a communications device initiates an outgoing call, the communications routing system notifies other devices of the outgoing call where the communications device and the other devices are associated with the same VoIP telephone number. Optionally, the other devices display that the outgoing call had been initiated.

### BRIEF DESCRIPTION OF THE DRAWINGS

The drawings illustrate, by way of example only, implementations of the present invention.

FIG. 1 is a schematic diagram of an overall communications system.

FIG. 2 is a schematic diagram of a communications routing system.

FIG. 3 is a schematic diagram of a mobile communications device of FIG. 1.

FIG. 4 is a schematic diagram of the overall communication system with QoS as connected to communications device 30 according to a further embodiment of FIG. 1.

FIG. 5 is a flowchart depicting a method for establishing an incoming voice call in the communications system of FIG. 1.

FIG. 6 is a flowchart depicting a method for establishing an outgoing voice call in the communications system of FIG. 1.

FIG. 7 is a flowchart depicting a method for maintaining an ongoing voice call in the communications system of FIG. 1.

### DETAILED DESCRIPTION

The present invention generally relates to providing wireless carrier services (e.g., voice calls, short message service or SMS messages, general data communications, etc.) with quality of service to VoIP telephone numbers where each VoIP telephone number is associated with one or more communications devices. While certain infrastructure may not operate under Internet Protocol (IP) (e.g., PSTNs, cellular base station networks, etc.), communications are routed to and from such infrastructure using IP to the extent possible. The present invention also generally relates to providing communications with QoS between communication devices operating under the same account (same VoIP telephone numbers), and tracking and managing prepaid balances for traditional carrier services (e.g., voice call minutes, SMS messages, etc.) that are routed, an may be delivered, over IP. Other aspects of the present invention will also become apparent in light of the following detailed description.

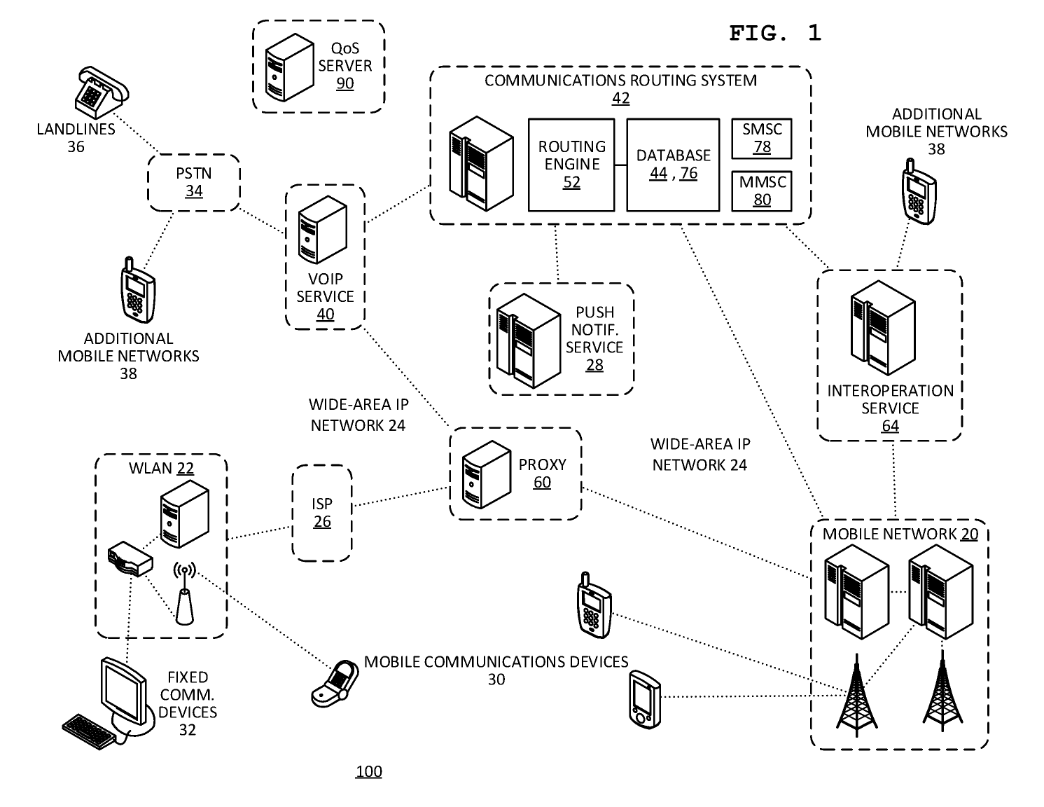

FIG. 1 shows an example of an overall electronic communications system 100.

The system 100 includes a mobile network 20, such as a wireless cellular network that operates under one or more known standards and technologies, such as Long Term Evolution (LTE), Worldwide Interoperability for Microwave Access (WiMAX), Enhanced Voice-Data Optimized (EVDO), Code Division Multiple Access (CDMA), HSPA (High Speed Packet Access), and similar. The mobile network 20 provides voice, data, and SMS services.

The system 100 further includes at least one wireless local-area network (WLAN) 22 that operates under one or more known standards and technologies, such as IEEE 802.11.

The mobile network 20 and the WLAN 22 each connect to a wide-area IP network 24, such as the Internet. The WLAN 22 can be connected to the wide-area IP network 24 by an Internet service provider (ISP) 26 or the similar entity. The mobile network 20 can be connected to the wide-area IP network 24 by a packet data interface.

The system 100 can further include a push notification service 28, such as the kind operated by Google Inc. of Mountain View, Calif., and Apple Inc. of Cupertino, Calif.

A plurality of mobile communications devices 30 can connect to the mobile network 20, via base stations and other infrastructure, and can further connect to the WLAN 22, via access points or similar. Examples of suitable mobile communications devices 30 include devices such as cellular telephones, smartphones, tablet computers, and the like that are provided with wireless communications interfaces suitable for the particular technologies used in the mobile network 20 and the WLAN 22. For sake of discussion it is assumed that all of the mobile communications devices 30 can connect to the mobile network 20 and WLAN 22. In various implementations, different mobile communications devices have different types of wireless communications interfaces, different configurations, and/or different access rights suitable for connection to different mobile networks and different WLANs.

For clarity of illustration, while FIG. 1 has dotted lines showing communication between certain parts of the system 100, all of the parts (such as WLAN 22 via ISP 26 and mobile network 20) connecting to the wide-area IP network 24 may be configured to communicate with each other. For example, dotted lines have not been included to show the communications of the Push Notification Service 28 with the plurality of mobile communications devices 30 via the mobile network 20 or the WLAN 22.

One or more stationary (fixed) communications devices 32, such as a desktop computer, laptop or wi-fi only device, server, or similar, can also connect to the WLAN 22, via a router or wired access point. For clarity, the term communications devices 30, 32 means mobile communications devices 30 and fixed communications devices 32.

The system 100 can further be connected to a public switched telephone networks (PSTN) 34 that supports connecting to a plurality of landline telephones 36 and additional mobile networks 38. The additional mobile networks 38 may have the same or similar features of the mobile network 20 and may be operated by different carriers and/or operated according to different technologies and standards when compared to the mobile network 20. For clarity, the mobile communications devices 30 connected to the mobile network 20 may also initiate to or receive voice calls directly from the PSTN 34 (which includes additional mobile networks 38) via the mobile network 20. Further, such voice calls, for example, may be via GSM (Global System for Mobile communication) from the mobile network 20. For convenience, such voice calls via the mobile network 20 in this disclosure are referred to as via a “voice channel”. This is in contrast to VoIP voice calls using a “data channel” of the mobile network 20 such as the Packet Data Channel of GPRS (General Packet Radio Service).

The system 100 further includes at least one voice-over-IP (VoIP) service 40, which can be configured to manage IP data streams related to VoIP communications (for example routing the IP data steam from communications device 30, 32 to another communications device 30, 32). All VoIP calls are streamed through the VoIP service 40. It also interfaces (transcoding as necessary) with the PSTN 34 and the additional mobile networks 38.

The VoIP service 40 may operate using one or more protocols, such as the Session Initiation Protocol (SIP), and one or more audio codecs, such as Opus. The VoIP service 40 can be connected to the PSTN 34 to allow VoIP calls to be place to and from landlines 36 and wireless devices in the additional mobile networks 38. One of the functions of the VoIP service 40 is to transcode the IP data streams so that it is compatible between different networks (for example between the mobile network 20 and the PSTN 34). In some implementations, the VoIP service 40 is a subcomponent of the mobile network 20 or the additional mobile networks 38.

The system 100 further includes a communications routing system 42 connected to the VoIP service 40, the push notification service 28, and the mobile network 20 via the wide-area IP network 24. In some implementations, the VoIP service 40 is directly connected to the communications routing system 42 via a local IP network distinct from the wide-area IP network 24. The communications routing system 42 is configured to direct the routing of communications of disparate types between mobile communications devices 30 via the mobile network 20 and/or the WLAN 22, and further with communications devices (including landlines 36) of the PSTN 34 and the additional mobile networks 38 as needed. Specifically, the communications routing system 42 may cooperate with integrated dialers of the mobile communications devices 30 to switch between data channels via the mobile network 20 and/or the WLAN 22, and voice channels via the PSTN 34.

The system 100 can further include a proxy 60 connected to the communications routing system 42, the WLAN 22, and the mobile network 20 via the wide-area IP network 24. In some implementations, the communications routing system 42 and the mobile communications devices 30 can be configured to route communications events through the proxy 60. The proxy 60 can be configured to handle VoIP call handoffs, as an alternative to the communications routing system 42 handling such. In addition, the proxy 60 can be configured to prioritize communications events associated with the enhanced 911 system, as an alternative to the communications routing system 42 doing so. For example, the proxy 60 can control quality of service (QoS) settings for various communications, so that 911 calls are prioritized. In some implementations, the VoIP service 40 is configured to route all relevant data through the proxy 60. A suitable proxy service can be in the form of that available from Pravala Networks Inc., of Kitchener, Ontario, Canada.

The system 100 can further include an interoperation service 64 connecting the communications routing system 42 to the mobile network 20 via the wide-area IP network 24. The communications routing system 42 can be connected to the interoperation service 64 via a virtual private network (VPN) established over the wide-area IP network 24. The interoperation service 64 is configured to interface with the various mobile networks 20, 38. The interoperation service 64 facilitates data communications between the communications routing system 42 and the mobile network 20. The interoperation service 64 further facilitates messaging services, such as SMS and MMS, between the communications routing system 42 and the additional mobile networks 38. The interoperation service 64 can be the kind provided by Syniverse of Tampa, Fla.

The communications routing system 42 includes at least one database, such as an accounts database 44 and one or more user data databases 76, configured to store a plurality of associations between unique account identifiers (e.g., user names) and device identifiers including mobile-network identifiers supported by the mobile network 20, such as mobile directory numbers (MDNs, or telephone numbers) of the mobile communications devices 30, and fixed identifiers of the fixed communications devices 32. For each user name, the database 44, 76 can store associations with a number of communications devices 30, 32. For example, each user (or user name or account identifier) has one associated VoIP telephone number. A user may further have one or more fixed communications devices 32 and/or one or more mobile communications devices 30. Each of the user's communications devices 30, 32 may be associated with the same VoIP telephone number associated with the user (or user name or account identifier). For some embodiments, a mobile device, such as a laptop or tablet, with only WLAN 22 capabilities can be treated as fixed communications devices 32. That is, a single VoIP telephone number may be associated with more than one communications device 30, 32 (i.e. a subset of the communications devices 30, 32).

One mobile communications device 30 can have a first MDN for SMS/MMS messages and VoIP calls, and a second MDN for services on the mobile network 20. The first and second MDNs are district and mutually different. The first MDN is used at the VoIP service 40 and the communications routing system 42 for VoIP calls. The first MDN is also used at the interoperation service 64 and communications routing system 42 for communicating SMS/MMS messages. In some implementations, the first MDNs are landline telephone numbers obtained from at least one competitive local exchange carrier (CLEC). The second MDN is used by the mobile network 20 to track data usage by each respective mobile communication device 30, with the communications routing system 42 using the second MDNs to map data usage to particular accounts. The database 44, 76 may further store push tokens to identify mobile communications devices 30 via the push notification service 28, so that the communications routing system 42 can send push notifications to the mobile communications devices 30. Alternatively or additionally, the database 44, 76 may store currently assigned IP addresses for the communications devices 30, 32.

In some embodiments, only the first (VoIP) MDN is used and the first MDN is registered with the mobile network 20 for data usage at the mobile network 20. For such embodiments, functionality described herein described with respect to the second (mobile network) MDN is performed using the first (VoIP) MDN.

In other embodiments, a VoIP telephone number is associated with each user name which is distinct from the MDNs of the one or more mobile communication devices 30 of the user. The IP addresses of the communications devices 30, 32 may be obtained when the communications devices 30, 32 contacts the communications routing system 42.

The communications routing system 42 further includes a routing engine 52 responsive to incoming communications events. Incoming communications events can include initiation of voice calls, ending of voice calls, communication of SMS/MMS messages, requests for data. The routing engine 52 is further configured to route data communications with the plurality of mobile communications devices 30 over the mobile network 20 and the WLAN 22 using the Internet, as well as with the plurality of fixed communications devices 32 over the WLAN 22 using the Internet. The routing engine 52 is further configured to initiate and end voice calls with communications devices 30, 32 as VoIP calls using the VoIP server 40, and to communicate SMS messages with the plurality of mobile communications devices 30 via the mobile network 20 and the WLAN 22 using the Internet, as well as with the plurality of fixed communications devices 32 over the WLAN 22 using the Internet.

The communications routing system 42 can further include a short message service center (SMSC) 78 and a multimedia message service center (MMSC) 80 configured to store, forward, convert and deliver SMS and MMS messages between the communications routing system 42 and the interoperation service 64. The SMSC 78 and MMSC 80 can be configured to communicate with the interoperation service 64 using the Short Message Peer-to-Peer (SMPP) protocol.

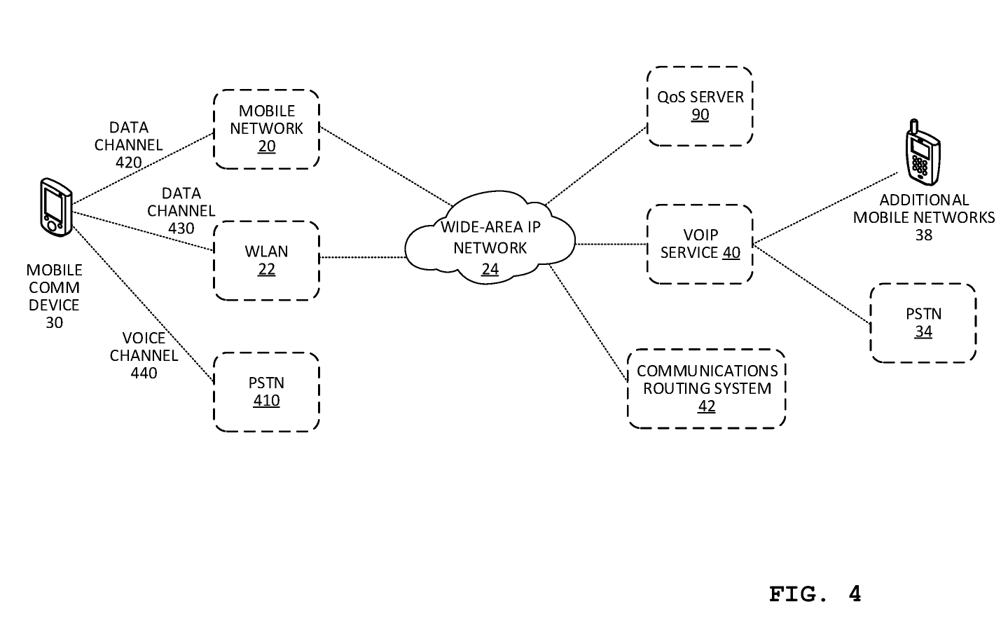

Each mobile communications device 30 and fixed communications device 32 can be associated with one of the unique account identifiers (e.g., user names) stored in the database 44, 76. This can be achieved by, for example, a client program executed on the mobile communications device 30 requiring a user log in (e.g., client 410 of FIG. 4). When a user is logged in to the client program, for example, the mobile communications device 30 becomes associated with the respective unique account identifier.

For each account identifier in the database 44, 76; there is associated a voice call log, voice mails, SMS/MMS messages, contacts, and other such account data. Such account data must be synchronized with the communications devices 30, 32 of each account identifier so that a user may review the same account data between different communications devices 30, 32 of the user.

Each account identifier can be associated with a plurality of mobile communications devices 30, and each of the mobile communications devices 30 can be associated with a first mobile-network identifier, such as a first MDN that is associated with the VoIP service 40. Each account identifier can be associated with a second mobile-network identifier, such as a second MDN that is associated with mobile data access on the mobile network 20. In some implementations, the second MDN is only associated with mobile data access on the mobile network 20 to the exclusion of access to circuit-switched voice services and SMS/MMS services that may be available on the mobile network 20. The mobile network 20 uses the second MDN to track data usage of the mobile communications device 30, which can be reported to the communications routing system 42. Hence, for each account identifier, voice services via the VoIP server 40 are conducted with one MDN and data services are conducted via the mobile network using a different MDN. The communications routing system 42 maps each MDN to a particular account for managing overall services to that account identifier.

An outgoing voice call from a communications device 30, 32 is conducted as follows. The communications device 30, 32 sends a call request to the VoIP service 40 via the WLAN 22, if connected, or otherwise via the mobile network 20. The communications device 30, 32 registers with the VoIP service 40 if not already registered. If the destination device is on the PSTN 34, the VoIP service 40 completes the call via the PSTN 34. If the destination device has an account with the communications routing system 42, then the VoIP service 40 notifies the communications routing system 42 of the call request. The communications routing system 42 then issues a push notification to the destination device (if connected via mobile network 20, through the push notification service 28) to notify the destination device of the call. Then the destination device registers with the VoIP service 40, if not already registered, and notifies the VoIP service 40 of call acceptance. The VoIP service 40 can notify the communications routing system 42 of call initiation and ending. When the proxy 60 is used, VoIP voice data is routed through the proxy 60. The outgoing voice call event is recorded in the associated account data of the account identifier in the communications routing system 42 so that it may be synchronized with the client programs on the other communications devices 30, 32 of the account identifier.

The mobile communications devices 30 can perform SIP registrations in a variety of ways.

For mobile communications devices 30 operating on iOS by Apple Inc., the mobile communication device 30 receiving a push notification does not immediately trigger SIP registration. Rather, the push notification informs the user of the incoming call, via an alert or similar. The user can then respond to the push notification by opening the client program, which then performs the SIP registration.

For mobile communications devices 30 operating on Android by Google Inc., the mobile communication device 30 can be configured to perform a SIP registration in response to receiving a push notification for an incoming call. That is, the SIP registration process can be started before the user has accepted the call.

In some embodiments, incoming voice calls may be directed to a VoIP telephone number associated with a subset of destination communications devices 30, 32. In such embodiments, the incoming voice call may arrive, for example, at the VoIP service 40 via the PSTN 34. In other examples, the incoming voice calls may arrive at the VoIP service 40 via the mobile network 20 or the WLAN 22. The VoIP service 40 notifies the communications routing system 42 of a call request for the VoIP telephone number. The communications routing system 42 then issues a push notification to the subset of the destination communications devices 30, 32 (through the push notification service 28, where connected to the mobile network 20) associated with the VoIP telephone number to notify the destination communications devices 30, 32 of the call. That is, each communications device 30, 32 may be notified of the incoming voice call to the VoIP telephone number. In particular, the communications routing system 42 may cooperate with respective integrated dialers of the communications devices 30, 32 to provide notifications of the incoming call.

When one communications device in the subset of the destination communication devices 30, 32 (associated with the particular VoIP telephone number) answers the incoming voice call, the communications routing system 42 then notifies the other devices in the subset of the communication devices 30, 32 that the incoming voice call has been answered. Optionally, the other devices in the subset of the communication devices 30, 32 displays that the incoming voice call has been answered. For example, the communications routing system 42 may cooperate with respective integrated dialers of the communications devices 30,32 to display that the incoming voice call has been answered.

Continuing with this example, where one of the communications devices 30, 32 initiates an outgoing call and the communications routing system 42 notifies the other devices of the outgoing call where the communications device 30, 32 and the other devices are associated with the same VoIP telephone number. In particular, the respective integrated dialers of the communications devices 30, 32 may display that an outgoing call had been initiated.

More generally, the communications routing system 42 notifies each communications device in the subset of the communications device 30, 32 associated with the same VoIP telephone number about the communication events (such as initiating a call, receiving a call, ending a call) that have occurred at any one of the devices. Each one of the communications devices 30, 32 in the subset of the communications device 30, 32 associated with the same VoIP telephone number will then be able to show the same call history as the other devices.

Alternatively, the communications routing system 42 stores a master call history for a VoIP telephone number and each of the associated devices then synchronizes with the master call history as needed.

While the previous example used dealt with voice calls, text messages can also be handled with a similar manner. In particular, it is advantageous to have a master text message log or database (with the particulars of each of the text messages) at the communications routing system 42 for synchronization with the devices as needed to show what text messages were sent and received as well as when.

It will be understood that events as described in the above examples for the logs or histories are not all inclusive and that numerous other example events have not been described but may be added in a particular implementation.

If the user of the destination communications devices 30, 32 accepts the call on one of the destination communication devices 30, 32, then the destination communications device 30, 32 registers with the VoIP service 40, if not already registered, and notifies the VoIP service 40 of call acceptance. The VoIP service 40 notifies the communications routing system 42 of call initiation and ending.

Incoming and outgoing voice calls made to or from a communications device 30, 32 associated with the communications routing system 42 are made using the VoIP telephone number, which is established at the VoIP service 40. When such a call is conducted as data via the mobile network 20, the second MDN of the relevant mobile communications device 30 is used to track the data usage on the mobile network 20.

In some embodiments, caller ID is based on the VoIP telephone number to the exclusion of the mobile network MDN. That is, the mobile network MDN is for tracking data usage only, and the VoIP telephone number is the basis for outgoing and incoming calls.

An outgoing SMS/MMS message can be sent by a communications device 30, 32 as follows. One or more IP data packets containing the SMS/MMS message are sent from the communications device 30, 32 to the communications routing system 42 via the WLAN 22, if connected, or otherwise via the mobile network 20. The sent data specifies a destination device using an MDN. The communications routing system 42 determines whether the MDN is stored in the database 44, 76 and thus whether the destination device is a communications device 30, 32 associated with the communications routing system 42. If the destination device is a communications device 30, 32 associated with the communications routing system 42, then the communications routing system 42 stores the message and sends a push notification to the destination communications device 30, 32 via the push notification service 28 (if connected via the mobile network 20). When a user at the destination communications device 30, 32 opens an SMS/MMS application/module or performs a similar action, the destination communications device 30, 32 fetches the stored message from the communications routing system 42. If the destination device is not associated with the communications routing system 42, then the communications routing system 42 sends the SMS/MMS message to the destination device via the interoperation service 64.

Incoming SMS/MMS messages for the communications devices 30, 32 arrive at the communications routing system 42 either directly from other communications devices 30, 32 that have accounts at the communications routing system 42 or via the interoperation service 64 for devices that are not associated with the communications routing system 42. The communications routing system 42 stores a particular SMS/MMS message and sends a push notification to the destination communications device 30, 32. When a user at the destination communications device 30, 32 opens an SMS/MMS application/module or performs a similar action, the destination communications device 30, 32 fetches the stored message from the communications routing system 42.

Incoming and outgoing SMS/MMS messages made to or from a mobile communications device 30 associated with the communications routing system 42 are made using the first MDN. When messages are sent as data through the mobile network 20, the second MDN of the respective mobile communications device 30 is used to track the data usage on the mobile network 20.

Incoming and outgoing SMS/MMS messages are recorded in the associated account data of the account identifier in the communications routing system 42 so that it may be synchronized with the client programs on the other communications devices 30, 32 of the account identifier. In some embodiments, this synchronization occurs as and when the user of the other communication devices 30, 32 accesses the associated client programs when the client programs contacts the communications routing system 42 to synchronize with the incoming and outgoing SMS/MMS messages, the voice call logs, the voice mails, and other such services including an address book of contacts.

Data communications between communications devices 30, 32 and between communications devices 30, 32 and data sources, such as web sites connected to the wide-area IP network 24, are performed via the WLAN 22, if connected, and otherwise via the mobile network 20.

The system further comprises a quality of services (QoS) server 90. The QoS server 90 determines the performance of a data channel to a communications device 30, 32 for a voice call. Where the performance of the data channel to a communications device 30, 32 degrades or drops, the QoS server 90 directs the communication routing system 42 to establish a new channel to the communications device 30, 32 to continue the voice call. In the event that all data channels are degraded or terminated, then the QoS server 90 directs the communications routing system 42 to continue the voice call via a voice channel over the PSTN 34 (or mobile network 20) when the mobile communications device 30 is connected to the mobile network 20.

The QoS server 90 is shown as a standalone component in FIG. 1, however, it may be a subcomponent of another component such as the VoIP Service 40 and the communications routing system 42. The QoS server 90 is connected to the wide-area IP network 24 and as such a connection can be made with any of the communications devices 30, 32.

For further clarity, it will be understood that the mobile communications devices 30 may be simultaneously connected to both the mobile network 20 and the WLAN 22. While mobile network 20 may generally provide a better performing data channel than the WLAN 22 for voice calls, the WLAN 22 may provide the data channel free of charge to users.

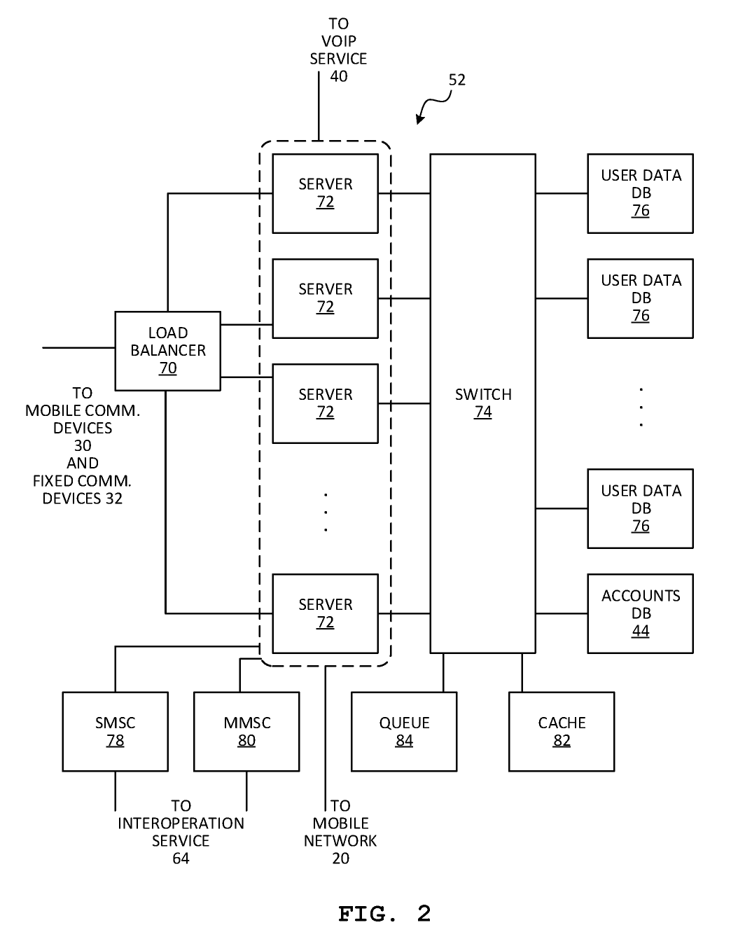

FIG. 2 shows a diagram of the communications routing system 42. The communications routing system 42 includes a load balancer 70, a plurality of servers 72, a switch 74, a plurality of user data databases 76, and the accounts database 44. The load balancer 70, servers 72, and switch 74 can be considered the routing engine 52. However, this is not limiting.

Communications devices 30, 32 connect to the load balancer 70 via the wide-area IP network 24 using a protocol, such as HTTP, HTTPS, or the like. The load balancer 70 is configured to balance requests from the communications devices 30, 32 among the servers 72.

The servers 72 are connected to the load balancer 70. The servers 72 can be configured to interface with the VoIP service 40 and the mobile network 20. The servers 72 can be clones having the same functionality. The servers 72 contain program code configured to interface with application programming interfaces (APIs) provided by the VoIP service 40 and the mobile network 20 and/or provide APIs for use by the VoIP service 40 and the mobile network 20. The servers 72 can be implemented using Nginx, PHP, and similar technology.

The SMSC 78 and the MMSC 80 are connected to the servers 72 and configured to store, forward, convert and deliver SMS and MMS messages between the servers 72 and the interoperation service 64 using, for example, the SMPP protocol and the MM4 protocol. The SMSC 78 and MMSC 80 can be configured to connect to the interoperation service 64 via a suitable binding and through a VPN tunnel. The SMSC 78 and MMSC 80 expose an API to the routing engine 52, such that the routing engine 52 can use the API to send outgoing SMS/MMS messages. For incoming messages, the SMSC 78 and MMSC 80 are configured to invoke an API of the routing engine 52 to cause the routing engine 52 to store a received message and send a notification of the message to the destination communications device 30, 32.

The switch 74 connects the servers 72 to the user data databases 76, the accounts database 44, a cache 82, and a queue 84.

The user data databases 76 store data for each of the users identified in the accounts database 44. Such user data can include the mobile network MDNs, session ID, password, residential address, contacts (i.e. address book of contacts), sessions, in-app purchases, subscriptions, settings, balance information, and communications events including call histories, voice mail content, SMS/MMS message transmission histories, and SMS/MMS message content. The user data databases 76 can be configured to store communications event histories for all user names in the accounts database 44, such that a particular user's history can be downloaded to any communications device 30, 32 with which the user logs in. The user data databases 76 can be implemented as database shards.

The user data is stored by the communications routing system 42 so that it may be synchronized with the client programs on the communications devices 30, 32 of the account identifiers (i.e. user accounts). In some embodiments, this user data synchronization occurs as and when the user accesses the client programs on the of the communication devices 30, 32 of the user. The user data include call histories and text message logs.

In addition, for some embodiments, the routing engine 52 is configured to answer incoming calls with a busy signal when one of the communications devices 30, 32 of associated with the VoIP telephone number is in another call. In other embodiments, the routing engine 52 is configured to instead ring (notification including by audio and/or vibration) the communications devices 30, 32 with the communications device 30, 32 is in the another call providing an indication (by audio or vibration).

The cache 82 can be checked for data prior to requesting data from the user data databases 76. In addition, requests can be queued in the queue 84, which can be implemented using Redis or similar technology.

The accounts database 44 stores the identity of the user data database 76 that stores the user data associated with each account identifier (user name), and can further store the VoIP telephone number for each user.

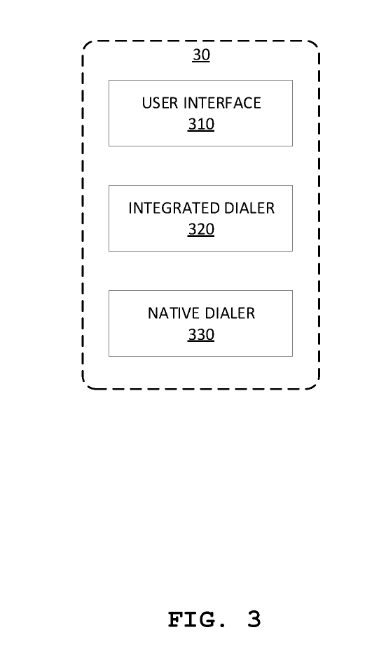

FIG. 3 shows a diagram of a mobile communications device 30 with cellular telephone service, the device 30 comprising a user interface (UI) 310, a client program (or integrated dialer) 320, and a native dialer 330. The UI 310 may include a display, speakers, vibrators, a keyboard (e.g. virtual or physical) and the like. The client program (or integrated dialer) 320 is, for example, an application for an android operating system or another operating system. The integrated dialer 320 is configured to provide communications capabilities to and from the mobile communications device 30. For example, the integrated dialer 320 may provide communications over a data channel via the mobile network 20, a data channel via the WLAN 22, or a voice channel via the PSTN 34. The native dialer 330 is another application which is implemented as part of the operating system for providing communications capabilities.

Specifically, mobile communications devices 30 are required to be able to provide emergency services at all times. The native dialer 330 is integrated with the operating system to allow the provision of emergency services and may be difficult to replace in the operating system for an application developed by a non-operating system developer. Therefore, it is advantageous to use the native dialer 330 for emergency services.

In an embodiment, the communications capabilities provided by the client program 320 (integrated dialer 320) takes precedence over the native dialer 330. That is, the communications capabilities provided by the integrated dialer 320 are default the communications capabilities at the mobile communications device 30. As such, user interface 310 of the mobile communications device 30 (e.g., at a display of the user interface 310), indications of the integrated dialer 320 (e.g., icons for the phone dialer, text message application, etc.) may be presented so that they are visible, available, and accessible to the user, while indications of the native dialer 330 are hidden or otherwise not made available to the user. In some embodiments, a user of the mobile communications device 30 is not even aware of the native dialer 330, for example, when the integrated dialer 320 is installed prior to the user taking possession of the mobile communications device 30. In other embodiments, a user may provide permissions to the integrated dialer 320 prior to the integrated dialer 320 taking possession of the mobile communications device 30.

For example, when a user makes a telephone call using a mobile communications device 30 where the integrated dialer 320 is the default communications application displayed on the user interface 310, the user launches or activates the integrated dialer 320 and dials a destination telephone number. The telephone call may also be initiated from any other app or a link to dial a telephone number i.e. a search that displays a telephone number which is recognized as a telephone number. In other examples, where the integrated dialer 320 is not the default communications application, the initiated telephone call by the native dialer 330 may be intercepted by the integrated dialer 320 to handle the telephone call accordingly.

Where is the destination telephone number is an emergency telephone number, control of the call origination corresponding to the destination telephone number is passed, released, or otherwise transferred from the integrated dialer 320 to the native dialer 330 of the mobile communications device 30. The call origination is processed by the native dialer 330 instead of by the integrated dialer 320. The native dialer 330 may then access operating system information, such as physical geographical location, for provisioning the emergency call to the emergency telephone number. Emergency telephone numbers may be a set of predetermined telephone numbers which may include one or more service, quick-dial, or abbreviated telephone numbers that have been assigned and/or defined by one or more regulatory bodies. For example, some of the emergency numbers may have a common format such as N-1-1 or some other suitable format or syntax.

When the destination telephone number is not included in or excluded from the set of predetermined numbers, control of the call origination is maintained by the integrated dialer 320, and the integrated dialer 320 makes a voice call on the mobile communications device 30 as shown in and described for FIG. 1.

FIG. 4 shows a diagram of the overall communication system 100 with QoS (Quality of Service) as connected to mobile communications device 30 according to one embodiment. The mobile communications device 30 is simultaneously connected, through the integrated dialer 320, to the WLAN 22 over a first data channel 430 and the mobile network 20 over a second data channel 420. The communications device 30 is further connectable to the PSTN 410 over a voice channel 440 for voice calls. The PSTN 410 herein includes the voice channel of the mobile network 20, but alternatively, it may be a voice channel of another mobile network of a different carrier from that of the mobile network 20. The mobile communications device 30 is further connected to the QoS server 90 via the WLAN to test the quality of the data channels 420 and 430.

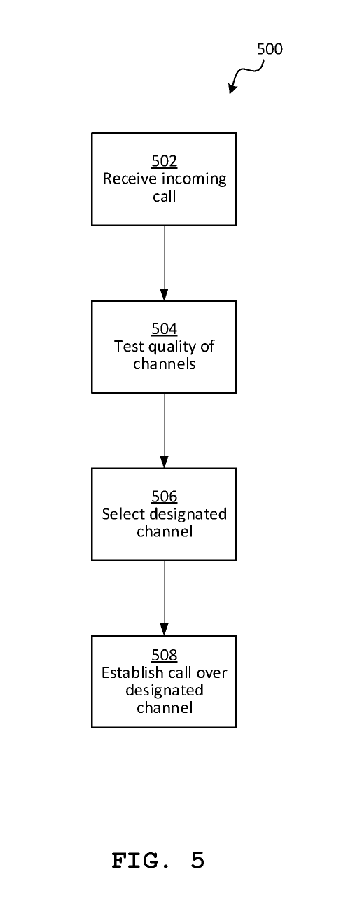

For an incoming voice call (a VoIP call) destined for a VoIP telephone number, reference is made to FIG. 5 depicting a method 500 for establishing the incoming voice call. The method 500 will be described in conjunction with the system of FIG. 4. Performance of the method 500 in other suitable systems is also contemplated.

At block 502, the incoming voice call is received at the VoIP service 40 (for example, from the PSTN 34 or additional networks 38). The communications routing system 42 directs the routing of the voice call to the associated communications device 30. Where a subset of communications devices 30, 32 are associated with the same VoIP telephone number, the communications routing system 42 may notify each communications device in the subset of the incoming voice call to the VoIP telephone number.

At block 504, before the incoming voice call is established at the communications device 30, the integrated dialer 320 of the communications device 30 sends packets (QoS test packets) to and receives packets from the QoS server 90 via data channel 420 of the WLAN 22 and, optionally, via the data channel 420 of the mobile network 20. The data communication paths (data channels 420, 430) to the communications device 30 are thus tested. The performance of each of the data channels 420, 430 are determined based on the quality or performance of the channel: for example, latency, jitter, and loss of the received packets received at both the QoS server 90 and the communications device 30.

Optionally, the voice channel 440 may also be tested such as by checking the signal strength. Depending the particular mobile network 20 base station and the user location, the data channels 420, 430 may be of better quality then the voice channel 440. It will be understood that this voice channel 440 testing may also be added to other examples of testing the QoS of the data communication paths as described herein.

At block 506, the integrate dialer 320 selects a designated channel for establishing the voice call based on the quality of the data channels 420 and 430. The designated channel may be one of the data channels 420, 430, or the voice channel 440. In some embodiments, the determination may further be based on the quality of the voice channel 440.

Optionally, the determination may always use the data channel 430 (WLAN 22) for such voice calls when the quality is sufficient. Alternatively, the selection of the data communication paths 420, 430, 440 to use for a telephone call may be configured to be selected on a best guess basis. The best guess, may be, for example, the channel having the highest probability of having a sufficient quality for example, based on testing, user experience, or historical data.

Where neither of the data channels 420, 430 are of sufficient quality or are not otherwise connected, the communication routing systems 42 accordingly selects the voice channel 440 as the designated channel.

At block 508, the integrated dialer 320 cooperates with the communications routing system 42 to route the call over the designated channel to establish the voice call. Specifically, the integrated dialer 320 and/or the communications routing system 42 direct the VoIP service 40 to route the voice call over the designated channel.

In some embodiments, after establishing the voice call at a particular communications device 30 in a subset of communications devices 30, 32 associated with the same VoIP telephone number, the communications routing system 42 may notify the other communications devices 30, 32 in the subset that the incoming voice call has been answered. For example, the respective integrated dialers 320 of the other communications devices 30, 32 in the subset may display an indication that the incoming voice call has been answered.

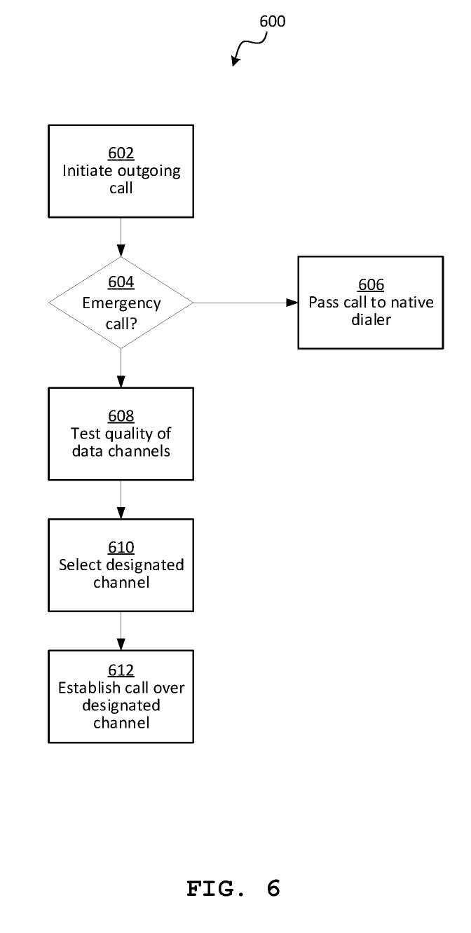

For an outgoing voice call, reference is made to FIG. 6 depicting a method 600 for establishing the outgoing voice call. The method 600 will be described in conjunction with the components described in FIG. 3 and FIG. 4. Performance of the method 600 in other suitable systems is also contemplated.

At block 602, the outgoing voice call to a destination telephone number is initiated from the integrated dialer 320 (or optionally from one of the other described methods). For example, the integrated dialer 320 may intercept an outgoing call initiated via the native dialer.

At block 604, the integrated dialer 320 determines if the destination telephone number is an emergency telephone number, for example, by comparing the destination telephone number to a set of predetermined telephone numbers.

If the destination telephone number is an emergency telephone number, the integrated dialer 320 proceeds to block 606. At block 606, the integrated dialer 320 passes control of the outgoing voice call to the native dialer 330.

If the destination telephone number is not an emergency telephone number, the integrated dialer 320 proceeds to block 608. At block 608, before the outgoing voice call is established, the integrated dialer 320 of the communications device 30 sends packets (QoS test packets) to and receives packets from the QoS server 90 via the data channel 420 of the WLAN 22 and, optionally, via the data channel 430 of the mobile network 20. The testing of the data channels 420, 430 may use, for example, 10 packets in each direction with the final packet (which could be a 11^{th} packet) from the QoS server 90 indicating the quality of the packets received at the QoS Server 90. The data communication paths (data channels 420, 430) to the communications device 30 are thus tested. The performance of each of the data channels 420, 430 are determined based on the quality or performance of the channel: for example, latency, jitter, and loss of the received packets received at both the QoS server 90 and the communications device 30. Optionally, the voice channel 440 may also be tested, such as by checking the signal strength.

At block 610, the integrated dialer 320 selects a designated channel for establishing the voice call based on the quality of the data channels 420 and 430. The designated channel may be one of the data channels 420, 430, or the voice channel 440. In some embodiments, the determination may further be based on the quality of the voice channel 440. Optionally, the determination may always use the data channel 430 of the WLAN 22 for outgoing voice calls when the quality is sufficient.

Where neither of the data channels 420, 430 are of sufficient quality or are not otherwise connected; the mobile communications device 30 accordingly selects the voice channel 440 as the designated channel.

At block 612, the integrated dialer 320 cooperates with the communications routing system 42 to route the call over the designated channel to establish the voice call. For example, the integrated dialer 320 may dial the PSTN 410 (this may be via a routing telephone number) to connect to the VoIP Services 40, where the outgoing destination telephone number is dialled to establish the voice call. Optionally, the communications device 30 may just direct dial the destination telephone number over the PSTN 410.

In some embodiments, after establishing the outgoing voice call at a particular communications device 30 in a subset of communications devices 30, 32 associated with the same VoIP telephone number, the communications routing system 42 may notify the other communications devices 30, 32 in the subset that the outgoing voice call has been initiated. For example, the respective integrated dialers 320 of the other communications devices 30, 32 in the subset may display an indication that the outgoing voice call has been initiated.

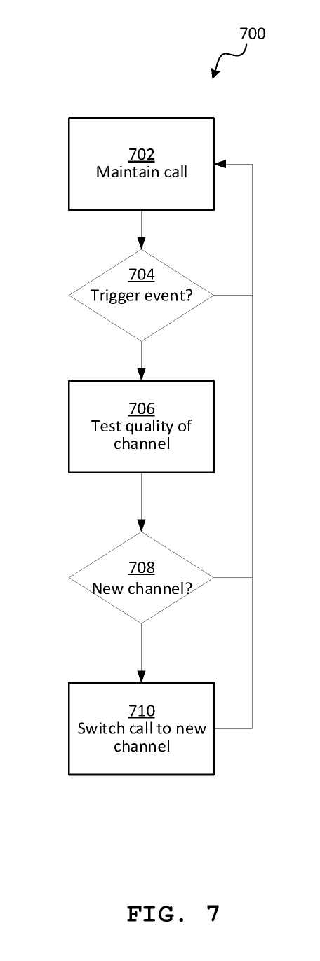

Referring now to FIG. 7, a method 700 of maintaining an ongoing voice call is depicted.

At block 702, the ongoing voice call is maintained.

At block 704, the integrated dialer 320 determines whether a trigger event to test the quality of the channels has occurred. For example, the trigger event may be the quality of the current channel (i.e. the channel over which the voice call is currently established) dropping below a threshold level. In other embodiments, testing of the data channels 420, 430, and, optionally, the voice channel 440, may occur periodically (such as every minute) through the duration of the voice call, hence the trigger event may be passage of a predetermined period of time.

If a trigger event has not occurred, the call continues to be maintained at block 702.

If a trigger event has occurred, the integrated dialer 320 proceeds to block 706. At block 706, the integrated dialer 320 tests the quality of the data channels 420, 430, and optionally, the voice channel 440. For example, the integrated dialer 320 may send and receive packets from the QoS server 90 to test the quality of the data channels 420, 430, for example, based on latency, jitter, and loss of packets at the QoS server 90 and the communications device 30.

At block 708, the integrated dialer 320 determines whether to select a new channel for maintaining the voice call. For example, if the quality of the current channel does not meet the threshold level, the integrated dialer 320 may determine that a new channel is necessary. In other embodiments, if the integrated dialer 320 determines that a new channel has a higher quality than the current channel, the integrated dialer 320 make the determination to switch to the new channel.

If no new channel is selected, the call continues to be maintained at block 702.

If a new channel is selected, at block 710, the integrated dialer 320 cooperates with the communications routing system 42 to switch the voice call to the new channel. For example, the voice call may be switched between one of: the data channel 420 of the mobile network 20, the data channel 430 of the WLAN 22, and the voice channel 440 of the PSTN 34. In particular, the switch may be performed without notifying the user or otherwise affecting the ongoing voice call.

The techniques discussed above show that evolving mobile network technologies, such as LTE, can be made available to prepaid users in a simplified, and efficient manner using the Internet Protocol. In addition, a reduced deployment of physical infrastructure is required. Further, more efficient spectrum usage can be realized.

While the foregoing provides certain non-limiting example implementations, it should be understood that combinations, subsets, and variations of the foregoing are contemplated. The monopoly sought is defined by the claims.

What is claimed is:

1. An electronic communications system comprising:
a mobile network to provide communications for a plurality of mobile communications devices over a wide-area IP network via respective first data channels, wherein mobile directory numbers are associated with the plurality of mobile communications devices, and wherein at least one mobile device of the plurality of mobile devices comprises an integrated dialer and a native dialer;
a wireless local-area network (WLAN) to provide communications between a plurality of communications devices over the wide-area IP network via respective second data channels, wherein the plurality of communications devices includes the plurality of mobile communications devices;
a Voice over Internet Protocol (VoIP) service coupled to the mobile network and the WLAN via the wide-area IP network, wherein the plurality of communications devices are associated with VoIP telephone numbers;
a public switched telephone network (PSTN) to provide communications between the plurality of communications devices via respective voice channels, the PSTN coupled to the VoIP service; and
a communications routing system coupled to the plurality of communications devices and coupled to the VoIP service, the communications routing system configured to cooperate with the integrated dialer of the at least one mobile device to route, at the at least one mobile device, a voice call over a designated channel, the designated channel selected from: a first data channel of the mobile network, a second data channel of the WLAN, and a voice channel of the PSTN.

2. The system of claim 1, further comprising
a quality of service server coupled to the plurality of mobile communications devices via the wide-area IP network for determining a first quality of the first data channel to the at least one mobile communications devices via the mobile network and a second quality of the second data channel to the at least one mobile communications devices via the WLAN;
wherein the integrated dialer cooperates with the communications routing system to switch the voice call between one of: the first data channel of the mobile network, the second data channel of the WLAN, and the voice channel of the PSTN based on the first quality of the first data channel and the second quality of the second data channel.

3. The system of claim 1, wherein the integrated dialer passes control of the voice call to the native dialer to originate telephone calls to telephone numbers which are included in a set of predetermined telephone numbers.

4. The system of claim 3, wherein the set of predetermined telephone numbers comprises emergency telephone numbers.

5. The system of claim 1, wherein each communications device in a subset of the communications devices are associated with a same VoIP telephone number, and wherein the communications routing system notifies each communications device in the subset of an incoming voice call to the same VoIP telephone number.

6. The system of claim 5, wherein one communications device in the subset of the communication devices answers the incoming voice call, and wherein the communications routing system notifies other communications devices in the subset that the incoming voice call has been answered.

7. The system of claim 6, wherein respective integrated dialers of the other communications devices in the subset display an indication that the incoming voice call has been answered.

8. The system of claim 1, wherein each communications device in a subset of the communications devices are associated with a same VoIP telephone number, and wherein when one communications device in the subset initiates an outgoing call, the communications routing system notifies other devices in the subset of the outgoing call.

9. The system of claim 8, wherein respective integrated dialers of the other communications devices in the subset display an indication that the outgoing call had been initiated.

10. A method in an electronic communications system, the method comprising:
initiating a voice call between a Voice over Internet Protocol (VoIP) service coupled to a mobile network and a wireless local-area network (WLAN) via a wide-area internet protocol network and a mobile communications device associated with a VoIP telephone number;
selecting, at an integrated dialer of the mobile communications device, a designated channel from a first data channel of the mobile network, a second data channel of the WLAN, and a voice channel of a public switched telephone network (PSTN); and
routing, at a communications routing system, the voice call over the designated channel to establish the voice call.

11. The method of claim 10, further comprising:
determining, at a Quality of Service (QoS) server, a first quality of the first data channel and a second quality of the second data channel; and
wherein selecting the designated channel comprises selecting the designated channel based on the first quality of the first data channel and the second quality of the second data channel.

12. The method of claim 10, further comprising passing control of the voice call to a native dialer of the mobile communications device to originate telephone calls to telephone numbers which are included in a set of predetermined telephone numbers.

13. The method of claim 12, wherein the set of predetermined telephone numbers comprises emergency telephone numbers.

14. The method of claim 10, further comprising notifying, by the communications routing system, each communications device in a subset of the communications devices of an incoming voice call to the VoIP telephone number, wherein each communications device in the subset is associated with the VoIP telephone number.

15. The method of claim 14, further comprising, when one communications device in the subset answers the incoming voice call, notifying, by the communications routing system, other communications devices in the subset that the incoming voice call has been answered.

16. The method of claim 15, further comprising displaying, by respective integrated dialers of the other communications devices in the subset, an indication that the incoming voice call has been answered.

17. The method of claim 10, further comprising, when one communications device in a subset of the communications devices initiates an outgoing voice call from the VoIP telephone number, notifying, by the communications routing system, other communications devices in the subset of the outgoing voice call, wherein each communications device in the subset is associated with the VoIP telephone number.

18. The method of claim 17, further comprising displaying, by respective integrated dialers of the other communications devices in the subset, an indication that the outgoing voice call has been initiated.
